(19) United States
(12) Patent Application Publication
(10) Pub. No.: US 2021/0082390 A1
(43) Pub. Date: Mar. 18, 2021

(54) PASSIVE HEARING AID

(71) Applicant: James Riedl, Gold Canyon, AZ (US)

(72) Inventor: James Riedl, Gold Canyon, AZ (US)

(21) Appl. No.: 16/983,865

(22) Filed: Aug. 3, 2020

Related U.S. Application Data
(60) Provisional application No. 62/901,143, filed on Sep. 16, 2019.

(51) Int. Cl. G10K 11/28; G10K 11/08

(52) U.S. Cl. CPC G10K 11/28; G10K 11/08

(57) ABSTRACT

Disclosed is a passive headset apparatus for directing sound coming from the front of a user into the user's ear and its external auditory canal without the use of batteries, speakers or electronics. In particular, it directs high frequency sound of about 500 Hz and up, directly into the canal, improving clarity for loss of hearing while shielding and muting sound from the sides of the ears. The external auditory canal follows two compound angles leading into the skull. This invention focuses sound into the angles of the external auditory canal using sound deflectors configured to direct sound at the correct angles.

### CROSS REFERENCE TO RELATED APPLICATION

This application claims priority to U.S. Provisional Patent Application to James Riedl entitled “PASSIVE HEARING AID,” Ser. No. 62/901,143, filed Sep. 16, 2019, the disclosures of which are hereby incorporated entirely herein by reference.

### BACKGROUND OF THE INVENTION

### Technical Field

This invention relates generally to passive hearing aids, and particularly to a passive headset apparatus for directing sound, coming from the front of a user, into the user's ear and its external auditory canal.

### State of the Art

Many persons with reduced hearing ability, and particularly those with sensorineural hearing loss, may have difficulty hearing frontal sounds (those sounds directed to a person and coming from the front of the person). In particular, such persons may have difficulty hearing and understanding the higher-frequency content of speech, music in the frequency range of 200 to 2000 Hz, and the sibilant letters s, h, and f, resulting in muffled hearing.

People with reduced hearing ability often turn to using hearing aids. Most conventional hearing aids use a miniature microphone, speaker, electronics, and battery, and are inserted directly into the ear's exterior auditory canal. Other conventional devices fit behind the ear, where a small hollow tube carries the sound from the device into the canal. Conventional hearing aids are typically expensive, and many require custom fitting and adjustment, as well as regular cleaning and maintenance. In addition, many conventional hearing aids become uncomfortable through daily use. Furthermore, batteries lose power and require replacement.

Other conventional hearing aids are passive in nature, in that they do not use electronics. Some are primarily for hunting use. They may be unusually large and bulky, using straps, fasteners and/or a headband for use with a cap, which is expensive to manufacture. They may have mechanical parts, with joints and fasteners, causing discomfort to the user and leading to maintenance issues as joints and fasteners wear out. Some claim to amplify sound, or focus sound, when they do not.

Still other conventional passive hearing aids make related claims as to focal point and/or parabolic design of the ear cups, which require constant adjustment to reflect sound into the ear. However, they don't address directing sound at correct angles into the pinna of the exterior ear canal. These also have the disadvantages of high manufacturing costs as well as comfort, durability, and maintenance issues.

In general, conventional passive hearing aids may have any or all of the following disadvantages, without limitation:

1) Mechanical designs of multiple parts that are large, bulky, unwieldy, of frail design, awkward, and susceptible to failure;

2) Claims of reflection of sound into the ear with no consideration of what angle the sound must be reflected at to correctly direct the sound into the exterior auditory canal of the ear, or requiring angle adjustments;

3) Claims of preserving natural spectral balance free from colorations or resonances in the audio spectrum while ignoring the need for clarity of hearing, which is the higher frequency content of sound for speech and/or music;

4) Claims that they focus sound into the ear, typically by a parabolic reflector, which is not possible with such reflectors, and/or claiming amplification, which is only possible by electronic speakers as used in active hearing aids;

5) Costly manufacturing due to tooling, material costs of parts, and labor of assembly; and

6) Safety issues and discomfort due to rivets, bolts, nuts, screws, excessive weight, and protrusions that chaff the head and/or the ear of a user, with little or no consideration of durability and maintenance requirements.

Accordingly, what is needed is a safe and comfortable passive hearing aid that is easy and inexpensive to manufacture, has few moving parts, with reflectors to direct high-frequency frontal sounds at correct angles into the exterior auditory canal of the ears, without use of electronic components.

### SUMMARY OF THE INVENTION

The present invention relates to passive hearing aids and particularly to a passive headset apparatus for directing sound coming from the front of a user into the user's ear and its External Auditory Canal.

A passive hearing aid comprises a headset configured to fit over the top of a user's head, and a pair of sound deflectors coupled to opposed ends thereof, such that the sound deflectors are proximate the user's ears when worn by the user. In preferred embodiments, the headset and pair of sound deflectors is a single piece, of unitary construction. The passive hearing aid directs high frequency sound of about 500 Hz and up, directly into the canal, improving clarity for loss of hearing while shielding and muting sound from the sides of the ears.

To accommodate different head sizes of different users, embodiments of a passive hearing aid may comprise an adjuster coupled thereto, which may be a tubular component, of deformable material, configured to fit around a top portion of the headset. The adjuster may provide cushioning to enhance comfort to a user. In addition, an adjuster may have a thick side and a thin side. The adjuster may be rotatable, such that, in a first configuration, the thick side faces downward, and the thin side faces upward, and, in a second configuration, the thick side faces upward, and the thin side faces downward, thus accommodating users of different head sizes.

In embodiments of the present invention, the sound deflectors are angled and curved, such that frontal sound waves are reflected off sound deflectors and generally directed into the external auditory canals, thereby enhancing the ability of the user to hear frontal sounds.

The sound deflectors, being generally small in size, are suited to deflect high-frequency sound into the pinna and into the external auditory canal. High-frequency frontal sounds, having high frequencies that are typical of speech and other sounds of interest emanating from such devices as a television, personal computer, mobile device, or music speakers, is thereby generally directed into the pinna and into the external auditory canal, while other low-frequency sounds, not of interest to the user, pass by the sound deflectors without being reflected toward the ear.

In addition, sound deflectors provide a barrier to the ear, that blocks otherwise interfering sounds that emanate from the sides or rear of the user from being directed to the user's ear.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in conjunction with the Figures, wherein like reference numbers refer to similar items throughout the Figures, and:

FIG. 1 is a perspective view of a passive hearing aid, according to an embodiment;

FIG. 2A is a top view of a headset of a passive hearing aid before it is formed to fit a head of a user, according to an embodiment;

FIG. 2B is a front view of a headset of a passive hearing aid after it is formed to fit a head of a user, according to an embodiment;

FIG. 2C is a side view of a headset of a passive hearing aid after it is formed to fit a head of a user, according to an embodiment;

FIG. 2D is a top view of a headset of a passive hearing aid after it is formed to fit a head of a user, according to an embodiment;

FIG. 3A is a front view of a headset of a passive hearing aid, being worn on the head of a user, and having a head-band adjuster rotated for a small head, according to an embodiment;

FIG. 3B is a front view of a headset of a passive hearing aid, being worn on the head of a user, and having a head-band adjuster rotated for a large head, according to an embodiment;

FIG. 3C is two illustrations of a head-band adjuster of a passive hearing aid, the first being decoupled from a headset of a passive hearing aid, and the second being coupled to a headset of a passive hearing aid, according to an embodiment;

FIG. 4A is a front view of a headset of a passive hearing aid, being worn by a user, according to an embodiment;

FIG. 4B is a side view of a headset of a passive hearing aid, being worn by a user, according to an embodiment;

FIG. 4C is a top view of a headset of a passive hearing aid, being worn by a user, according to an embodiment;

FIG. 5A is a side view of a pinna of a human ear;

FIG. 5B is a front view of a human head, showing the angle at which the external auditory canal enters the head;

FIG. 5C is a top view of a human head, showing the angle at which the external auditory canal enters the head;

FIG. 6A is a top view of a deflector of a passive hearing aid, showing sound waves being directed into the external auditory canal of a user, according to an embodiment; and

FIG. 6B is a front view of a deflector of a passive hearing aid, showing sound waves being directed into the external auditory canal of a user, according to an embodiment.

### DETAILED DESCRIPTION OF EMBODIMENTS OF THE INVENTION

As discussed above, embodiments of the present invention relate to passive hearing aids and particularly to a passive headset apparatus for directing sound coming from the front of a user into the user's ear and its External Auditory Canal. A passive hearing aid, of the present invention, directs high frequency sound of about 500 Hz and up, directly into the canal, improving clarity for loss of hearing while shielding and muting sound from the sides of the ears.

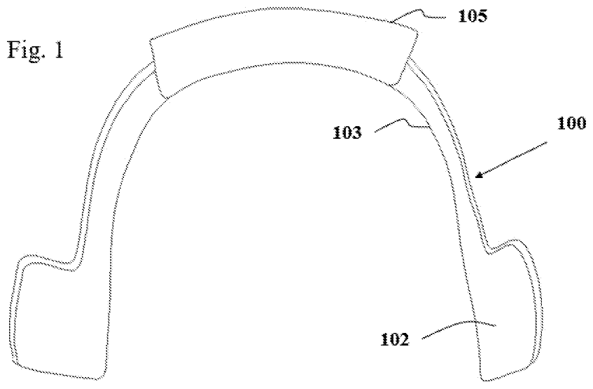

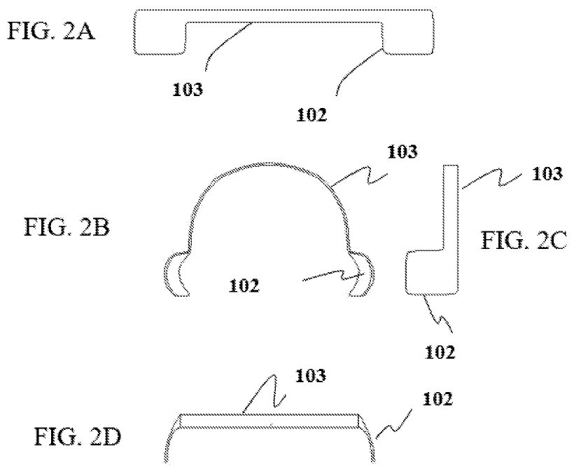

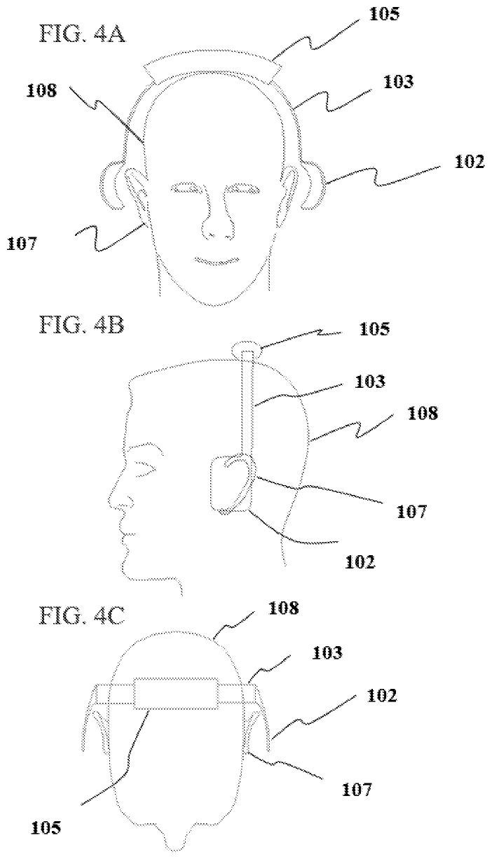

Referring to the drawings, as shown in FIGS. 1-4C, a passive hearing aid 100, of the present invention, comprises a headset 103 configured to fit over the top of a user's head 108, and a pair of sound deflectors 102 coupled to opposed ends thereof, such that the sound deflectors 102 are proximate the user's ears 107 when worn by the user, as shown in FIGS. 4A-C. In preferred embodiments, the headset 103 and pair of sound deflectors 102 is a single piece, of unitary construction, thus eliminating many of the disadvantages of conventional passive hearing aids, including, without limitation: mechanical designs of multiple parts that are large, bulky, unwieldy, of frail design, awkward, and susceptible to failure; costly manufacturing due to tooling, material costs of parts, and labor of assembly; and safety issues and discomfort due to rivets, bolts, nuts, screws, excessive weight, and protrusions, or the like, that chaff the head and/or the ear of a user, with little or no consideration of durability and maintenance requirements.

In a preferred embodiment, the unitary headset 103 with sound deflectors 102 may be simply manufactured of a sheet of thermoplastic material that is cut, such as by a laser, for example, heated, formed into shape, and allowed to cool. Alternative manufacturing methods include plastic injection molding and/or computer numerical control (CNC) methods that are well-known to a person of ordinary skill in the art. In any case, each of these methods is relatively simple and inexpensive when compared to the manufacture of conventional hearing aids.

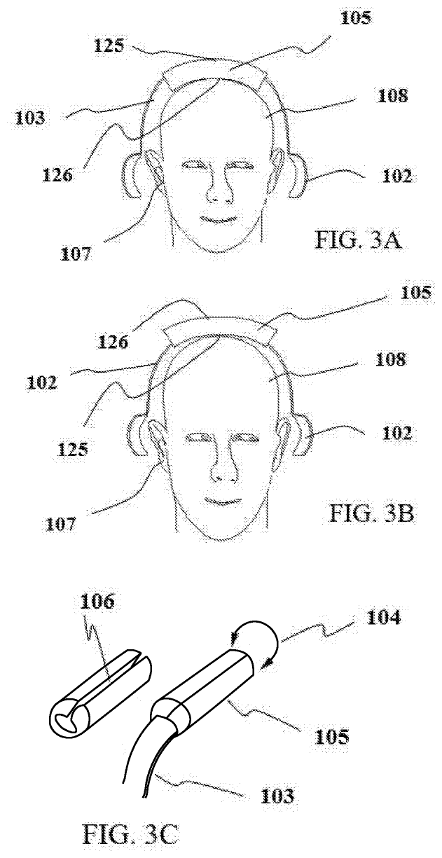

To accommodate different head sizes of different users, embodiments of a passive hearing aid 100 may comprise an adjuster 105. An adjuster 105 may be a tubular component, of deformable material, configured to fit around a top portion of the headset 103, as shown in FIGS. 3A-3C. The adjuster 105 may provide cushioning to enhance comfort to a user. In addition, an adjuster 105 may have a thick side 126 and a thin side 125. The adjuster 105 may be rotatable, as shown by bi-directional arrow 104 in FIG. 3C, such that, in a first configuration, the thick side 126 faces downward, and the thin side 125 faces upward, as shown in FIG. 3A, and, in a second configuration, the thick side 126 faces upward, and the thin side 125 faces downward, as shown in FIG. 3B. A user may rotate the adjuster 105 between the first configuration, as shown in FIG. 3A, to accommodate fit to a smaller head 108, and the second configuration, as shown in FIG. 3B, to accommodate fit to a larger head 108.

As shown in FIG. 3C, an adjuster 105 may comprise a longitudinal slit 106 along one of the thick side 126 or the thin side 125, to allow for insertion of the top portion of the headset 103 into the adjuster 105, and to allow for simple interchangeability of adjusters 105 of different colors and styles.

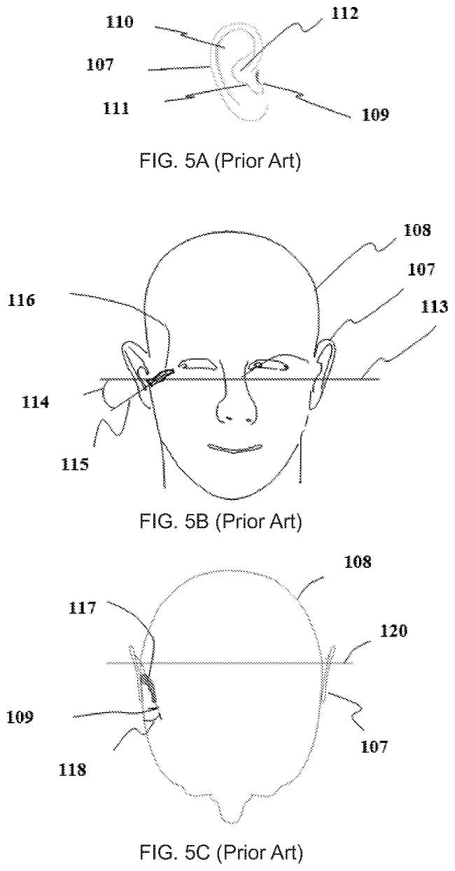

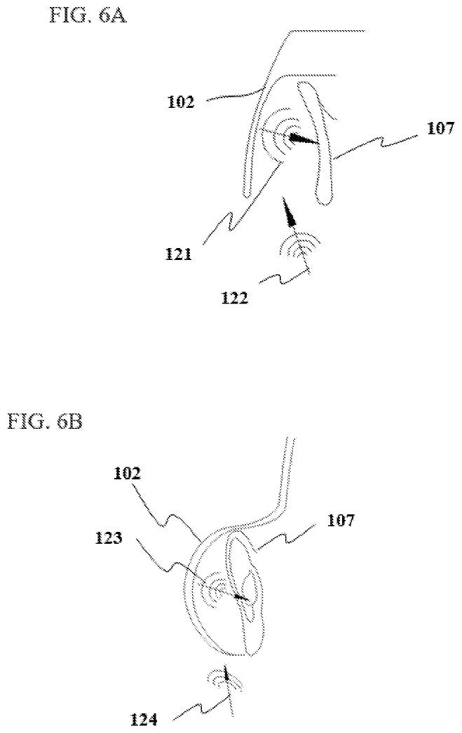

Referring to the drawings, FIG. 5C is a top view of a user's head 108, showing reference line 120 between the two ears 107 of the user. With respect to reference line 120, a longitudinal axis 109 of the external auditory canal 116 of the ear 107, is offset by angle 118, which is the angle between a line perpendicular to reference line 120 and the longitudinal axis 109 of the external auditory canal 116. In embodiments of the present invention, sound deflector 102 is angled, with respect to reference line 120, when worn by a user, as shown in FIG. 4C, such that frontal sound waves 122 are reflected off sound deflector 102 and generally directed into the external auditory canal 116, thereby enhancing the ability of the user to hear frontal sounds, as further shown in FIG. 6A.

Referring to the drawings, FIG. 5B is a front view of a user's head 108, showing reference line 113 between the two ears 107 of the user. With respect to reference line 113, a longitudinal axis 115 of the external auditory canal 116 of the ear, is offset by angle 114, which is the angle between reference line 113 and the longitudinal axis 115 of the external auditory canal 116. In embodiments of the present invention, sound deflector 102 is angled and curved, with respect to reference line 113, when worn by a user, as shown in FIG. 4A, such that sound waves 124 are reflected off of sound deflector 102 and generally directed into the external auditory canal 116, thereby enhancing the ability of the user to hear sounds, as further shown in FIG. 6B.

Sound deflectors 102 may be about 2 square inches to 2.5 square inches in size. The sound deflectors 102, being generally small in size, are suited to deflect high-frequency sound into the pinna 107 and into the external auditory canal 116. High-frequency frontal sounds, having high frequencies that are typical of speech and other sounds of interest emanating from such devices as a television, personal computer, mobile device, or music speakers, is thereby generally directed into the pinna 107 and into the external auditory canal 116, while other low-frequency sounds, not of interest to the user, pass by the sound deflectors 102 without being reflected toward the ear 107.

In addition, sound deflectors 102 provide a barrier to the ear 107, as shown in FIGS. 4B and 4C, that blocks otherwise interfering sounds that emanate from the sides or rear of the user from being directed to the user's ear 107. In this way, the user is better able to hear frontal sounds of interest without interference from interfering sounds that emanate from the sides or rear of the user.

The components defining any passive hearing aid may be formed of any of many different types of materials or combinations thereof that can readily be formed into shaped objects provided that the components selected are consistent with the intended operation of a passive hearing aid. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as copper, zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any passive hearing aid may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, sewing, any combination thereof, and/or the like for example, depending on, among other considerations, the particular material forming the components. Other possible steps might include sand blasting, polishing, powder coating, zinc plating, anodizing, hard anodizing, and/or painting the components for example. In any case, it is an important aspect of the present invention that the sound deflectors and headset are of unitary construction, and that the passive hearing aid is free of the undesirable mechanical designs and disadvantages of conventional passive hearing aids, including: multiple parts that are large, bulky, unwieldy, of frail design, awkward, and susceptible to failure; costly manufacturing due to tooling, material costs of parts, and labor of assembly; and safety issues and discomfort due to rivets, bolts, nuts, screws, excessive weight, and protrusions, or the like, that chaff the head and/or the ear of a user, with little or no consideration of durability and maintenance requirements.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

what is claimed is:

1. A passive hearing aid, comprising:
a headset of unitary construction and of inverted U-shape, configured to be worn over a user's head, comprising:
a first sound deflector portion at a first end thereof, comprising a first inner surface and an opposed first outer surface, wherein the first inner surface is disposed proximate a first ear of the user when worn by the user, wherein the first sound deflector portion is disposed along a first angle with respect to the first ear to deflect frontal sounds off the first inner surface and into the first ear along a longitudinal axis of a first ear canal of the first ear; and
a second sound deflector portion at a second end thereof, comprising a second inner surface and an opposed second outer surface, wherein the second inner surface is disposed proximate a second ear of the user when worn by the user, wherein the second sound deflector portion is disposed along a second angle with respect to the second ear to deflect frontal sounds off the second inner surface and into the second ear along a longitudinal axis of a second ear canal of the second ear.

2. The passive hearing aid of claim 1, wherein each of the first and second inner surfaces is curved from a bottom portion thereof to a top portion thereof, in a concave fashion.

3. The passive hearing aid of claim 1, further comprising an adjuster removably coupled thereto, wherein the adjuster is tubular, of deformable material, and having a central opening therethrough from a first end thereof to a second end thereof for receiving a top portion of the headset therethrough, wherein a longitudinal axis of the central opening is offset from a longitudinal axis of the adjuster, wherein a thick side of an outer wall thereof is thicker than a thin side of the outer wall thereof, wherein the adjuster is adjustable between a large size configuration, wherein the thin side engages a top of the user's head when worn by the user, and a small size configuration, wherein the thick side engages the top of the user's head when worn by the user.

4. The passive hearing aid of claim 3, wherein the adjuster comprises a slit through the outer wall thereof from the first end thereof to the second end thereof

5. The passive hearing aid of claim 2, further comprising an adjuster removably coupled thereto, wherein the adjuster is tubular, of deformable material, and having a central opening therethrough from a first end thereof to a second end thereof for receiving a top portion of the headset therethrough, wherein a longitudinal axis of the central opening is offset from a longitudinal axis of the adjuster, wherein a thick side of an outer wall thereof is thicker than a thin side of the outer wall thereof, wherein the adjuster is adjustable between a large size configuration, wherein the thin side engages a top of the user's head when worn by the user, and a small size configuration, wherein the thick side engages the top of the user's head when worn by the user.

6. The passive hearing aid of claim 5, wherein the adjuster comprises a slit through the outer wall thereof from the first end thereof to the second end thereof.
